(19) United States
(12) Patent Application Publication
(10) Pub. No.: US 2015/0043598 A1
(43) Pub. Date: Feb. 12, 2015

(54) METHOD FOR GENERATING OPTICAL PULSES AND OPTICAL PULSE GENERATOR

(71) Applicants: Raman Kashyap, Baie d'Urfe (CA); Sebastien Loranger, Montreal (CA); Victor Lambin Iezzi, Montreal (CA)

(72) Inventors: Raman Kashyap, Baie d'Urfe (CA); Sebastien Loranger, Montreal (CA); Victor Lambin Iezzi, Montreal (CA)

(21) Appl. No.: 14/454,220

(22) Filed: Aug. 7, 2014

Related U.S. Application Data
(60) Provisional application No. 61/863,504, filed on Aug. 8, 2013.

(51) Int. Cl. H01S 3/30; H01S 3/094; H01S 3/16; H01S 3/11; H01S 3/067; H01S 3/08

(52) U.S. Cl. CPC H01S 3/302; H01S 3/06754; H01S 3/08013; H01S 3/1698; H01S 3/11; H01S 3/094023
USPC 372/6

(57) ABSTRACT

The method generally has the steps of propagating a seed wave in an optical fiber; generating a wave of first order by stimulated Brillouin scattering of the seed wave in the optical fiber, the wave of first order having a frequency spectrally shifted from the seed wave and being backscattered from the seed wave; propagating the seed wave and the wave of first order in a feedback cavity thereby generating a plurality of waves of higher order, each wave of higher order being cascadely generated by the wave of previous order, each wave of higher order being backscattered and having a frequency spectrally shifted from its corresponding wave of previous order and forming a frequency comb with the seed wave and the wave of first order; the frequency comb generating optical pulses; and propagating the generated optical pulses out of the feedback cavity.

### REFERENCE TO RELATED APPLICATIONS

This patent application claims priority of U.S. provisional Application Ser. No. 61/863,504, filed on Aug. 8, 2013, the contents of which are hereby incorporated by reference.

### FIELD

The improvements generally relate to methods and devices involving stimulated Brillouin scattering (SBS), and more specifically discloses a method of generating picosecond pulses using SBS.

### BACKGROUND

Optical pulse generators are well known in the art. These are generally used in communication systems, in optical clocks, in writing waveguides, in generating nonlinear effects for sensing such as Raman spectroscopy. An example of application would be to convey bits of information along kilometers of underground optical fibers for transmission of electronic data or long distance telephone calls.

A typical optical pulse generator can be characterised by the energy contained in each of the generated pulses, the width of the pulses, its tunability, the repetition rate and its spatial and spectral shape. For some applications, like laser ablation, pulses of high energy are required to reach an ablation threshold in order for the material to be processed without the need of high repetition rates. For other applications, such as in communication systems, pulses having a short width, lower peak power, at high repetition rates are of particular importance, since it allows more bits of information to be communicated every second, while avoiding unwanted nonlinear effects. In normal pulse generation, the modes of a laser cavity are modulated by either phase or amplitude synchronously with the round-trip time of a cavity. If the modes arrive in phase, then the modes are locked, which leads to pulse generation. This may be understood by the Fourier principle, in which the modes with a fixed difference in frequency and the pulses thereby generated form a Fourier pair. The generation of pulses thus has required an active intervention to force the modes to lock either through a modulator, or a nonlinear medium, such as a Kerr-mode locking in which the highest energy “pulse” is favoured to oscillate within a cavity. These methods require the cavity to be matched through the physical length to the pulse rate required.

Although existing optical pulse generators have been satisfactory to a certain degree, there remains room for improvement, particularly in terms of addressing the wavelength tunability, the tunability of the pulse width, the tunability of the repetition rate and the stability over time associated with such systems.

### SUMMARY

A method is described herein which demonstrates the use of SBS in laser pulse generation.

In accordance with one aspect, there is provided a method for generating optical pulses, the method comprising the steps of: propagating a seed wave in an optical fiber; generating a wave of first order by stimulated Brillouin scattering of the seed wave in the optical fiber, the wave of first order having a frequency spectrally shifted from the seed wave and being backscattered from the seed wave; propagating the seed wave and the wave of first order in a feedback cavity thereby generating a plurality of waves of higher order, each wave of higher order being cascadely generated by the wave of previous order, each wave of higher order being backscattered and having a frequency spectrally shifted from its corresponding wave of previous order and forming a frequency comb with the seed wave and the wave of first order; the frequency comb generating optical pulses; and propagating the generated optical pulses out of the feedback cavity.

In accordance with another aspect, there is provided an optical pulse generator comprising: a seed wave generator; an optical fiber coupled to the seed wave generator, the optical fiber being adapted to generate a wave of first order by stimulated Brillouin scattering with the seed wave, the wave of first order having a frequency spectrally shifted from the seed wave and being backscattered from the seed wave; a feedback cavity associated to the optical fiber, the feedback cavity configured to propagate, in the optical fiber, the seed wave, the wave of first order and a plurality of waves of higher order, each wave of higher order being cascadely generated by the wave of previous order, each wave of higher order being backscattered and having a frequency spectrally shifted from its generating wave thereby providing a frequency comb usable to generate optical pulses; and an output coupler configured to propagate the generated optical pulses out of the feedback cavity.

The optical pulse generator can be used in an optical clock, in waveguide writing, in generation of nonlinear effects for sensing or in an optical time domain reflectometer, to name a few examples.

It will be noted that, as will be readily understood by persons of skill in the art, a sensor using the optical pulse generator can be used to sense temperature or strain with the optical fiber. The sensor is thus referred to herein as a strain-temperature sensor, or simply as a temperature sensor, notwithstanding the fact that the ‘temperature’ sensor can be used instead to sense strain. In other words, the expression temperature sensor as used herein is not to be interpreted restrictively as excluding strain sensing.

Many further features and combinations thereof concerning the present improvements will appear to those skilled in the art following a reading of the instant disclosure.

### DESCRIPTION OF THE FIGURES

In the figures,

FIG. 1 is a schematic diagram of an optical pulse generator comprising a feedback cavity configured with a reflector for coupling waves of even and odd orders out of the feedback cavity;

FIG. 2 is a graph showing an example of the output power as a function of the wavelength for the optical pulse generator of FIG. 1 having a length of single mode optical fiber of 10 km;

FIG. 3 is a graph showing an example of the intensity as a function of the autocorrelation time for comparing a theoretical calculation with an autocorrelation measurement for the optical pulse generator of FIG. 1 having a length of single mode optical fiber of 10 km;

FIG. 4 is a schematic diagram of an optical pulse generator comprising a feedback cavity configured to couple the wave of even orders in a first dependent feedback cavity and to couple the wave of odd orders in a second feedback cavity;

FIG. 5 is a graph showing an example of the power output as a function of the wavelength for the optical pulse generator of FIG. 4 having a length of single mode optical fiber of 10 km;

FIG. 6 is a graph showing an example of the intensity as a function of the autocorrelation time for comparing a theoretical calculation with an autocorrelation measurement for the optical pulse generator of FIG. 4 having a length of single mode optical fiber of 10 km;

FIG. 7A is a graph showing an example of an output spectrum having five (5) stimulated Brillouin scattering waves;

FIG. 7B is a graph showing an example of an output spectrum having sixteen (16) stimulated Brillouin scattering waves;

FIG. 7C is a graph showing an example of an output spectrum having twenty-eight (28) stimulated Brillouin scattering waves;

FIG. 7D is a graph showing an example of the pulse width associated with the output spectrum of FIG. 7A;

7E is a graph showing an example of the pulse width associated with the output spectrum of FIG. 7B;

7F is a graph showing an example of the pulse width associated with the output spectrum of FIG. 7C;

FIG. 8A is a graph showing few examples of the power as a function of the wavelength for the optical pulse generator of FIG. 4 having varying wavelength seed wave;

FIG. 8B is a graph showing few examples of the power as a function of the autocorrelation time for the optical pulse generator of FIG. 4 having varying wavelength seed wave;

FIG. 9 is a graph showing the relation between a frequency shift as a function of the wavelength of the seed wave different kind of optical fiber;

FIG. 10 is a schematic diagram of the strain-temperature sensor;

FIG. 11A is a graph showing examples of the beat frequency intensity as a function of the beat frequency for different temperature difference for a temperature sensor and for waves of various orders;

FIG. 11B is a graph showing examples of the beat frequency intensity as a function of the beat frequency for different temperature difference for a strain sensor and for waves of various orders;

FIG. 12A is a graph showing examples of the frequency shift difference as a function of temperature for several waves of higher order; and

FIG. 12B is a graph showing examples of the frequency shift difference as a function of strain for several waves of higher order.

### DETAILED DESCRIPTION

The optical pulse generator disclosed herein generally comprises a seed wave generator, an optical fiber and a feedback cavity. The seed wave is typically adapted to generate a wave of first order, or Stokes wave of first order, by stimulated Brillouin scattering (SBS) in the optical fiber. One skilled in the art would know that each wave generated by SBS can be backscattered from its generating wave along with being spectrally shifted from the latter. It is known that SBS is a four wave mixing nonlinear phenomenon involving three components: a seed wave (or optical pump), an acoustic wave and a wave of first order (Stokes wave). The generated wave of first order generally has a narrow bandwidth and is counter-propagating from the seed wave. The frequency shift can be further determined by material properties, temperature and strain of the optical fiber in which the SBS occurs.

In a favorable configuration, SBS can be cascaded to generate waves of multiple orders having a certain phase relation (phase-locked) one to the other. With an appropriate feedback cavity, waves of first and higher orders can be generated within the feedback cavity. For example, the seed wave generates a counter-propagating wave of first order, the wave of first order generates a counter-propagating wave of second order, the wave of second order generates a counter-propagating wave of third order, and so on. With such a configuration, the feedback cavity can be customized to isolate the waves of even orders (second, fourth, sixth, eighth, etc.) from the waves of odd orders (first, third, fifth, seventh, etc.), or customized to provide the waves of even and odd orders (first, second, third, fourth, fifth, etc.).

One skilled in the art would appreciate that each wave of higher order is spectrally shifted from its generating wave thereby providing a frequency comb usable to generate optical pulses (V. Lugovoi, “Theory of mode locking at coherent brillouin interaction,” Quantum Electronics, IEEE Journal of 19, 764-769 (1983).). Indeed, a frequency comb in which the teeth (or peaks) are phase-locked is known to be able to generate stable optical pulses (“Lasers”, A. E. Siegman, University Science Books, 1986, p. 1054).

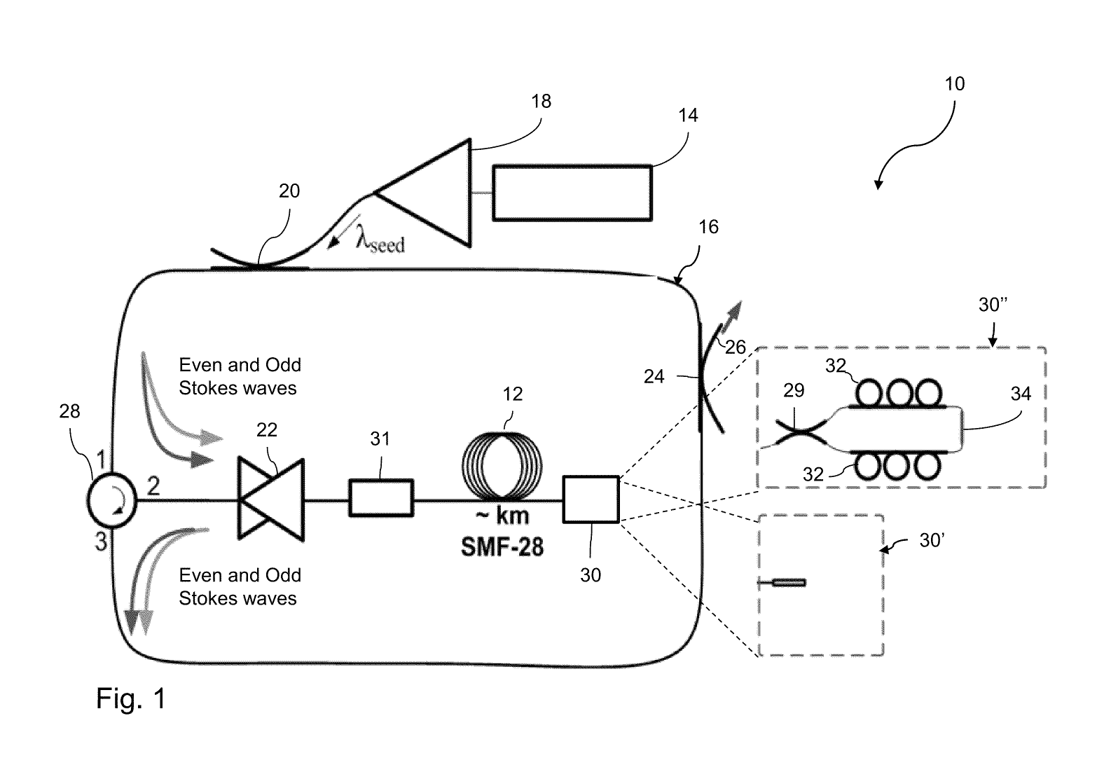

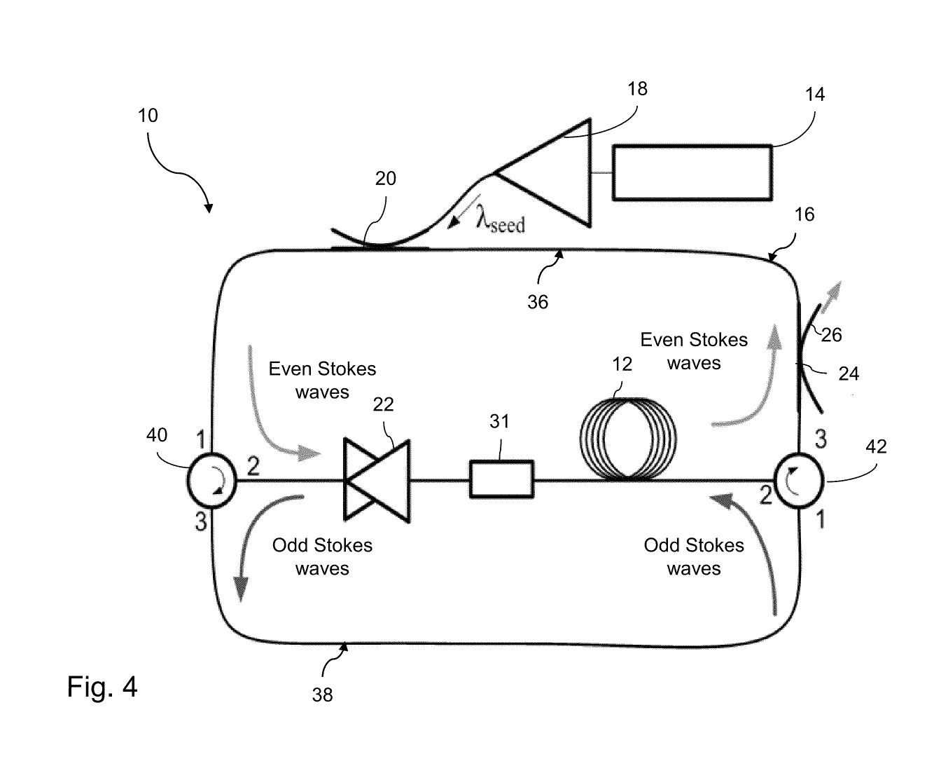

FIGS. 1 and 4 show the schematic diagram of two exemplary configurations of the optical pulse generator 10. In these two configurations, the optical pulse generator 10 comprises an optical fiber 12, a seed wave generator 14 and a feedback cavity 16. Particularly, the seed wave generator 14 can be any narrow band laser (few MHz) having an emission wavelength in the C-band (1520 to 1570 nm), such as a distributed feedback (DFB) diode laser, although the emission wavelength can also be in the L-band (1565 nm to 1625 nm). The seed wave generator 14 is amplified externally to the feedback cavity 16 with an external erbium-doped fiber optical amplifier (EDFA) 18. In this specific embodiment, the external optical amplifier 18 is a Pritel FA-30 erbium-doped fiber amplifier that can amplify the seed wave approximately from 50 mW to 400 mW, depending on the desired seed power. Once the seed wave is optically amplified, the seed wave is coupled into the feedback cavity 16 with an input coupler 20. This input coupler 20 is generally used to inject 5% of the power of the seed wave inside the feedback cavity 16, although as low as 1% can be injected in another embodiment. Within the feedback cavity 16, an internal optical amplifier 22 (or a bidirectional EDFA) is used to amplify the seed wave and the waves generated by SBS. Using EDFAs as a gain medium has the advantage of providing a low SBS threshold and also a seed wave of tunable wavelength. The optical fiber 12 used as a SBS gain medium can be provided as a bundle, a spool, or a roll of few centimeters to several kilometers, thus preferably of ˜5 m to 15 km, depending on the type of optical fiber used and on the type of optical amplifiers used (i.e., more efficient power amplifiers can yield shorter lengths of optical fiber 12). In these two configurations, an output 26 of the optical pulse generator 10 is provided typically using a 95/5 output coupler 24 that can be optically connected in the feedback cavity 16, although it may be suitable to use a 99/1 output coupler in another embodiment.

In order to generate multiple waves by SBS (or Stokes waves), a specific SBS threshold power must be reached. In fact, as exhaustively described by Agrawal (G. Agrawal, Nonlinear Fiber Optics 4th ed. (Elsevier, 2007).), the SBS threshold power depends on the Brillouin gain which itself depends on material properties of the optical fiber, on an effective mode area of the optical fiber, and on an absorption coefficient of the optical fiber. For instance, the SBS threshold power for an optical fiber of length varying between 5 km and 10 km wherein the optical fiber is, as one skilled in the art would refer to as an SMF-28 is approximately, 4 mW. Typically, the SBS power threshold is lower in a feedback cavity configuration than only as an optical fiber. Consequently, with a seed wave typically reaching 100 mW (only 5% of this is injected inside the cavity, thus inside the SBS medium), the generation of SBS waves of various orders is possible. Although the optical fiber 12 can be a conventional single mode fiber, the optical fiber 12 can alternatively be an optical fiber made of a nonlinear material (or a highly nonlinear material), i.e. a material having a nonlinear coefficient higher than a nonlinear coefficient of a conventional single mode fiber, for instance. The optical fiber 12 made of a nonlinear material enables easier generation of nonlinear effects such as SBS. Accordingly, when made of a nonlinear material, the required length of the optical fiber 12 can be less than would be required with a conventional single mode fiber. In some embodiments, the optical pulse generator 10 has an optical fiber 12 made of a nonlinear material, such as chalcogenide, and which has a length of a few centimeters, e.g. 5 cm or 38 cm as described by Buttner et al. (T. F. Buttner, I. V. Kabakova, D. D. Hudson, R. Pant, C. G. Poulton, A. C. Judge, et al., “Phase-locking and Pulse Generation in Multi-Frequency Brillouin Oscillator via Four Wave Mixing,” Scientific reports, vol. 4, 2014.”). The nonlinear material is generally defined as a material in which the dielectric polarization responds nonlinearly to the electric field of the light.

Now referring specifically to FIG. 1, the optical pulse generator 10 is configured so that the waves of even order and the waves of odd orders are coupled out of the feedback cavity 16 using the output coupler 24. In this configuration, an optical circulator 28 having three ports, namely port 1, port 2 and port 3, can guide the seed wave to one end of the optical fiber 12. Once the sufficiently powered seed wave is guided or propagated from port 1 to port 2, it reaches the optical fiber 12 to generate a wave of first order that is backscattered back to the port 2 of the optical circulator 28 wherein is it coupled back in the feedback cavity 16 through port 3. In a cascade fashion, the wave of first order is guided from port 1 to port 2 to generate a wave of second order that is coupled back in the feedback cavity 16 from port 2 to port 3 of the optical circulator 28. Using the same reasoning, SBS generated waves of first order and waves of higher order can copropagate in the feedback cavity 16.

Still referring to FIG. 1, a reflector 30 can be provided at the other end of the optical fiber 12. This reflector 30 can be used to guide the seed wave back in the optical fiber 12 hence generating another counter-propagating wave of first order. With sufficient power available in the feedback cavity 16, the reflector 30, preferably provided in the form of a reflective tipped fiber 30′ (e.g., a gold tipped fiber) or a Sagnac loop reflector 30″ comprising two polarization controllers (PC) 32 with a polarization-maintaining (PM) fiber 34 in-between, can reflect waves of multiple orders back in the optical fiber 12 to be further combined in the feedback cavity 16. One skilled in the art would appreciate that the Sagnac loop reflector can comprise a 50/50 coupler 29 along with a 15 cm PM optical fiber. The two PCs 32 shown in FIG. 1 can be used to optimize the reflectivity of the reflector 30 which is a function of the wavelength of the seed wave. In the embodiment of FIG. 1, the internal optical amplifier 22 is provided in the form of a bidirectional optical amplifier for amplifying both the waves propagating from the port 2 of the optical circulator 28 to the optical fiber 12 and the waves reflected by the reflector 30 propagating to the port 2 of the optical circulator 28. Alternatively, the internal optical amplifier 22 can be positioned in the feedback cavity 16 downstream from the input coupler 20 and upstream from the port 1 of the optical circulator 28. However, positioning the internal optical amplifier 22 downstream from the port 2 of the optical amplifier 28, as shown in FIG. 1, can contribute to reduce the amplitude difference between the seed wave and the Stokes waves, which can be desirable. Further in the embodiment of FIG. 1, the internal optical amplifier 22 is optically coupled to a filter 31 for limiting the amplified spontaneous emission (ASE) of at least the internal optical amplifier 22. The filter 31 can reduce the amplification window of the internal optical amplifier 22 down to 5 or 10 nm, for instance, as opposed to the conventional 30-40 nm, which causes the ASE to have a less damageable effect on the Stokes waves. Indeed, in some circumstances, the optical amplification can undesirably amplify the ASE instead (causing ASE lasing) of suitably amplifying the Stokes waves.

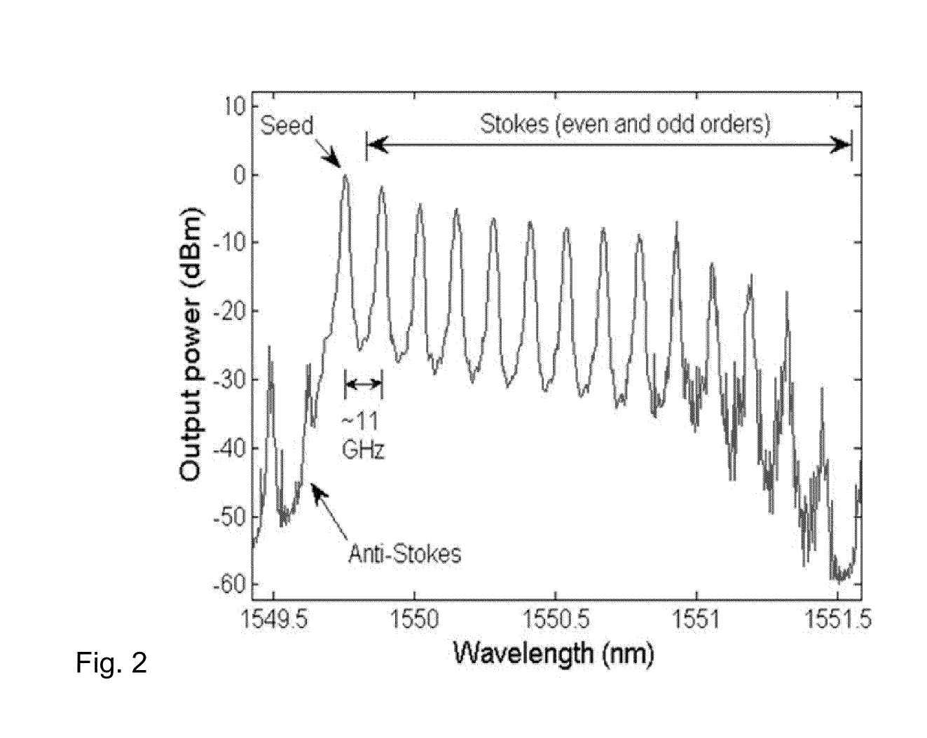

FIG. 2 is a graph showing an example of the output power as a function of the wavelength for the optical pulse generator configured as in FIG. 1. With the laser described above, the wave of first order along with waves of higher order (2^{nd} to 13^{rd}) are measured. Of these 13 waves orders, nine are found to be stable while the other four waves were found to be noisy within −20 dBs from the wave of first order. A spectral shift of 10.87 GHz was measured between each of the waves generated by SBS in the 1550 nm optical band, hence forming a frequency comb having several teeth. The analyser used to measure this optical spectrum can be any good-resolution (below 0.1 nm) optical spectrum analyser (OSA) such as one by Ando.

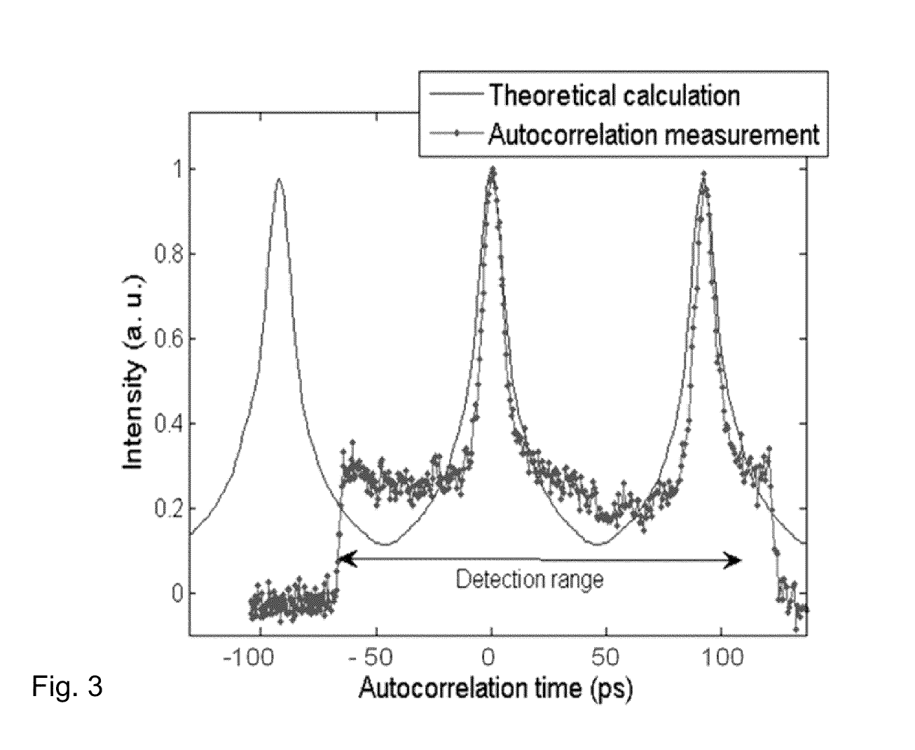

FIG. 3 shows an example of a graph of the intensity as a function of the autocorrelation time for comparing a theoretical calculation with an autocorrelation measurement for the optical pulse generator of FIG. 1. The pulse width measurements can be performed using a FR-103XL autocorrelator. With this configuration, pulses having a width of 3.5 ps to 30 ps were measured, each pulses being spaced of 92 ps one from the other. With such spacing between consecutive pulses, the repetition rate of the optical pulse generator is estimated to be at 10.87 GHz. The theoretical calculation presented in FIG. 3 is based on a fast Fourier transform (FFT) of a spectrum similar to the one presented in FIG. 2. Additionally, the continuous wave (CW) background measured can be associated to the un-equalized peaks in the spectrum, dispersion or Brillouin noise from other random modes.

FIG. 4 presents a schematic diagram of another embodiment of the optical pulse generator 10. The feedback cavity 16 is designed in a configuration adapted to isolate the waves of even orders from the waves of odd orders. In this configuration, a first dependent feedback cavity 36 and a second dependent feedback cavity 38 are connected by a first optical circulator 40 and a second optical circulator 42 wherein the optical fiber 12 is shared by the two dependent cavities, between the two optical circulators 40, 42, each optical circulator has three ports, namely port 1, port 2 and port 3. The first dependent cavity 36 is designed to guide the seed wave and the waves of even orders while the second dependent cavity 38 is designed to guide the counter-propagating waves of odd orders. In this embodiment, the seed wave provided in the first dependent feedback cavity is guided from port 1 to the port 2 of the first optical circulator 40 in order to generate a SBS wave of first order in the optical fiber 12. In this embodiment, both the seed wave and SBS waves of higher orders are being amplified by the internal optical amplifier 22 (coupled to the filter 31) between the ports 2 of the optical circulators 40, 42. Afterwards, the wave of first order, counter-propagating from the seed wave, is guided from port 2 to port 3 in the second dependent cavity 38 by the first optical circulator 40 where it is subsequently guided from port 1 to port 2 of the second optical circulator 42 to further generate a wave of second order in the optical fiber 12. This wave of second order, backscattered from the wave of first order, is inherently guided back in the first dependent cavity 36 from port 2 to port 3 of the second optical circulator 42, and so on. With the same reasoning, the seed wave and the waves of even orders are copropagating in the first dependent feedback cavity 36 while the waves of odd orders are copropagating in the second dependent feedback cavity 38.

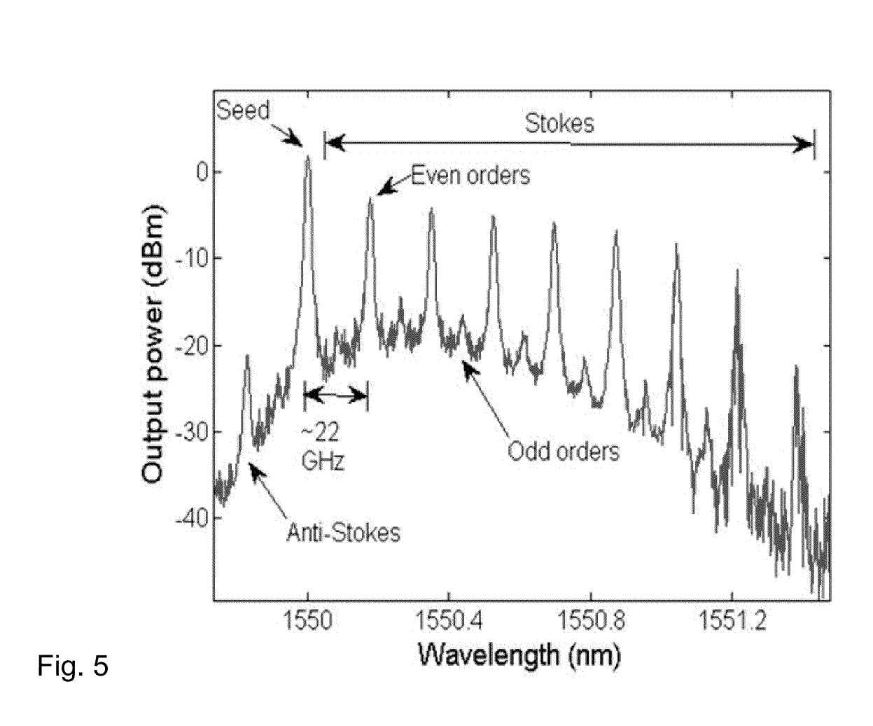

FIG. 5 is a graph showing an example of the power output as a function of the wavelength for the optical pulse generator of FIG. 4. Indeed, with this configuration, the waves of even orders can be predominant in the measured spectrum. Each wave of even order being separated by 21.74 GHz from the wave of previous even order. In this graph, six stable waves and 2 noisy waves are measured. Each noisy wave being within −20 dBs of the wave of second order. Since the waves of odd orders are no longer present, the frequency shift is doubled to reach approximately 21.74 GHz.

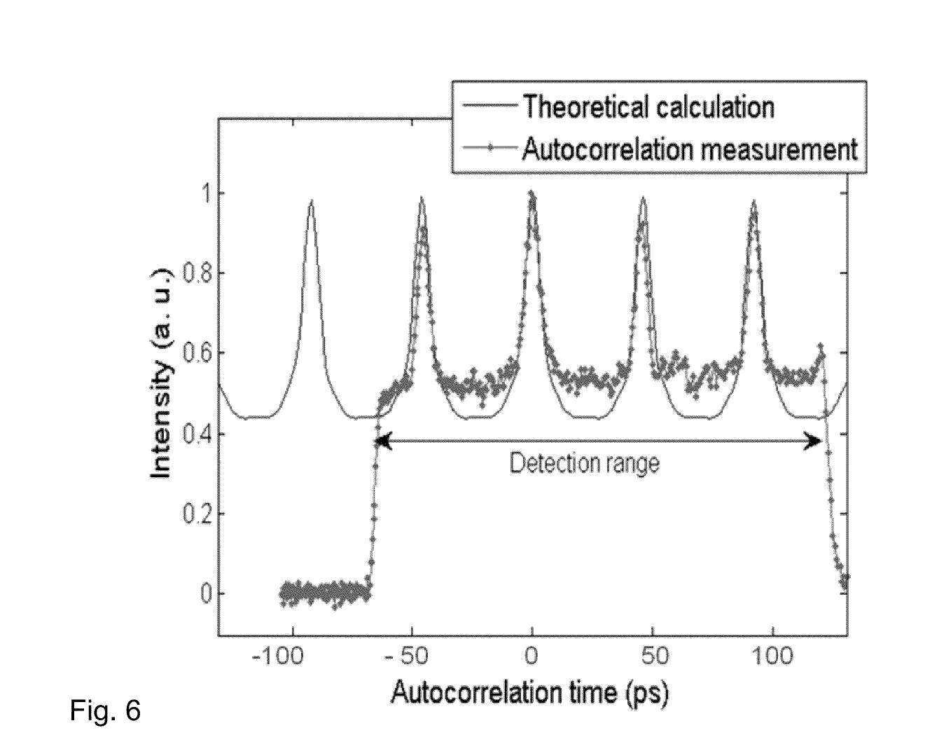

FIG. 6 is a graph showing an example of the intensity as a function of the autocorrelation time for comparing a theoretical calculation with an autocorrelation measurement for the optical pulse generator of FIG. 4. Indeed, with this configuration, the frequency shift reduces by a factor of two the spacing between consecutive pulses. The theoretical calculation shown in FIG. 6 is based on a FFT calculation of a spectrum similar to the one presented in FIG. 5.

In the configurations of FIG. 1 and FIG. 4, several parameters can be tuned. Typically, the input seed power is controllable via the external optical amplifier while a cavity gain is controllable via the internal optical amplifier 22. For these two optical amplifiers, there is a minimum power requirement in order for the SBS generated waves to be stable. If the input seed power is too low (<25 mW), what one skilled in the art would refer to as the amplified spontaneous emission (ASE) of the feedback cavity 16 can lead to unstable waves, which can generate SBS waves at random wavelengths. Furthermore, if the cavity gain is too low, the waves generated by SBS can be unstable and noisy. Above these minimum levels, increasing either the input seed power or the cavity gain simply increases the number of SBS generated waves (higher order), as long as saturation of the internal amplifier is not reached. These observations are noticeable using an optical fiber having between 5 km and 10 km, for instance, and it can also be observable for an optical fiber having between 1 km and 2 km. The length of the optical fiber can be above L_{eff} which can be defined as L_{eff}=1−exp(−α_{L})/α_{L} where α_{L} is a coefficient of attenuation of the optical fiber. For the roll of 15 km however, small variations on the measured spectrum were observed since the optical fiber is longer to an effective length described by Agrawal (G. Agrawal, “Nonlinear Fiber Optics” 4th ed. (Elsevier, 2007).). It is contemplated that the number of waves of higher order generated within the feedback cavity depends on the input seed power or the cavity gain. In some circumstances, the number of waves of higher order can be more than two waves of higher order. Accordingly, the number of waves of higher order can reach up to, for instance, 120 waves of higher order (Song, L. Zhan, J. Ji, Y. Su, Q. Ye, and Y. Xia, “Self-seeded multiwavelength Brillouin-erbium fiber laser,” Optics letters, vol. 30, pp. 486-488, 2005.) and 460 waves of higher order (R. Sonee Shargh, M. Al-Mansoori, S. Anas, R. Sahbudin, and M. Mandi, “OSNR enhancement utilizing large effective area fiber in a multiwavelength Brillouin-Raman fiber laser,” Laser Physics Letters, vol. 8, pp. 139-143, 2011.).

Cross-correlation between a first pulse and a second pulse is observed, which indicates a high degree of coherence between the output pulses. As it is known from Fourier analysis, the broader the frequency spectrum, the shorter the pulses. Therefore, since the measured spectrums of the optical pulse generators configured as in FIG. 1 and FIG. 4 are about the same width, the output pulses are about the same width also.

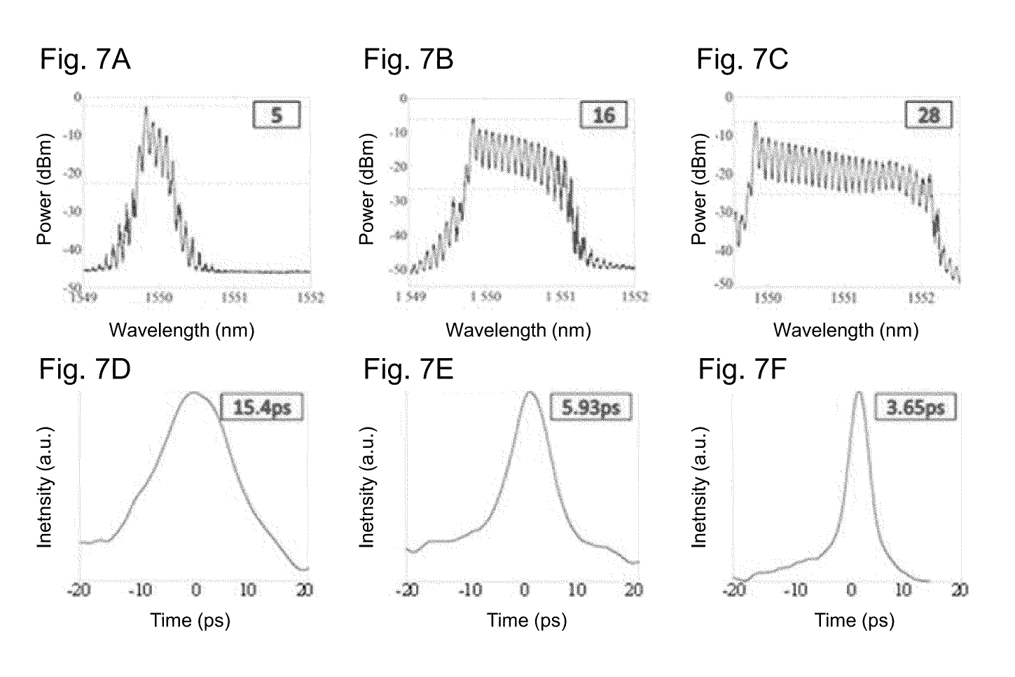

FIGS. 7A-C show examples of graphs showing output spectrums for different numbers of SBS waves for the optical pulse generator 10 shown in FIG. 4. FIGS. 7D-F show examples of pulse temporal shapes associated respectively with the output spectrums of FIGS. 7A-C. More specifically, FIG. 7A shows an output spectrum having five (5) SBS waves, FIG. 7B shows an output spectrum having sixteen (16) SBS waves and FIG. 7C shows an output spectrum having twenty-eight (28) SBS waves. Correspondingly, the output spectrums of FIG. 7A-C can be used, respectively, to obtain a pulses having widths of 15.4 ps, 5.93 ps and 3.65 ps, as shown in FIGS. 7D-F. The pulse widths presented is the full width measured at half maximum (FWHM). It is observed that as the number of SBS waves increases, e.g. as the power of the seed wave generator increases, the measured spectrum becomes broader so that the width of the pulses decreases, as can be theoretically predictable. As mentioned above, the input seed power and the cavity gain can be tuned to control the number of SBS waves, or the width of the spectrum measured. Therefore, the optical amplifiers 18 and 22 are usable to control the width of the generated pulses. It is contemplated that a spectrum without a CW background, or a spectrum having equalized peaks would be useful for pulse width tunability. Indeed, it is observed that the FFT calculations present shorter pulses as well as a more stable relationship between the pulse width and the number of SBS waves.

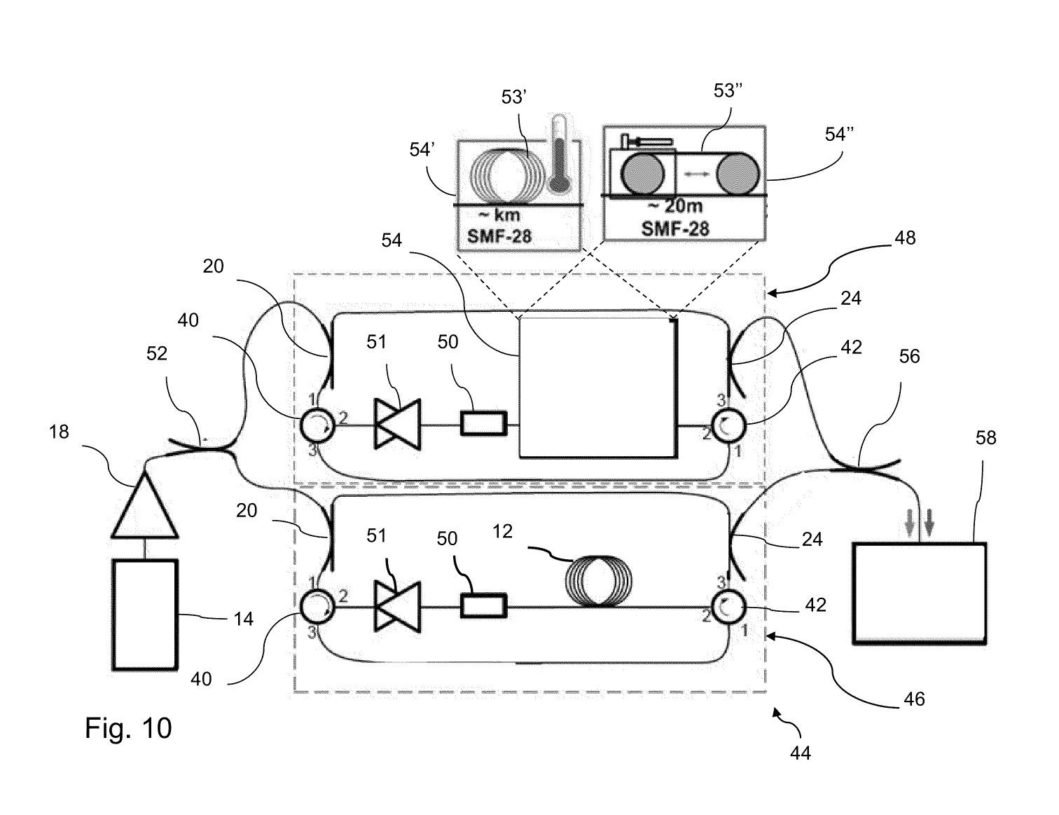

One skilled in the art would appreciate that the location of the output coupler is not limited to be subsequently positioned to the optical amplifier 22. Indeed, it has been shown that the location of the different components in the optical pulse generator can influence the output spectrum measured, e.g. the location of the internal optical amplifier 22 as discussed above (N. A. M. Hambali, M. A. Mandi, M. H. Al-Mansoori, A. F. Abas, and M. I. Saripan, “Investigation on the effect of EDFA location in ring cavity Brillouin-Erbium fiber laser,” Opt. Exp. 17, 11768-11775 (2009).). Also, reduced losses in the feedback cavity can improve to reduce the CW background in the output spectrum measured, since the cascade fashion in which the waves of higher orders are generated by SBS would not be limited by the losses. Is it also worthy to note that reduced losses leads to optical pulses of increased stability. Also to reduce the CW background, the feedback cavity 16 can comprise a filter configurable to a specific SBS frequency comb. This filter, illustrated in FIG. 10, can limit the CW background and therefore improve the pulse width tunability and limit ASE formation in the cavity. By selecting the SBS generated waves, higher repetition rates picosecond pulses are thus obtainable. In another embodiment, the seed wave generator 14 is a quasi-CW laser generator which can provide a modulated and pulsed signal (e.g., modulation at 20 kHz and pulse widths of 500 ns). Such quasi-CW laser generators can be used to adjust an initial phase of the signal which can be useful to reduce the undesirable effects of the ASE.

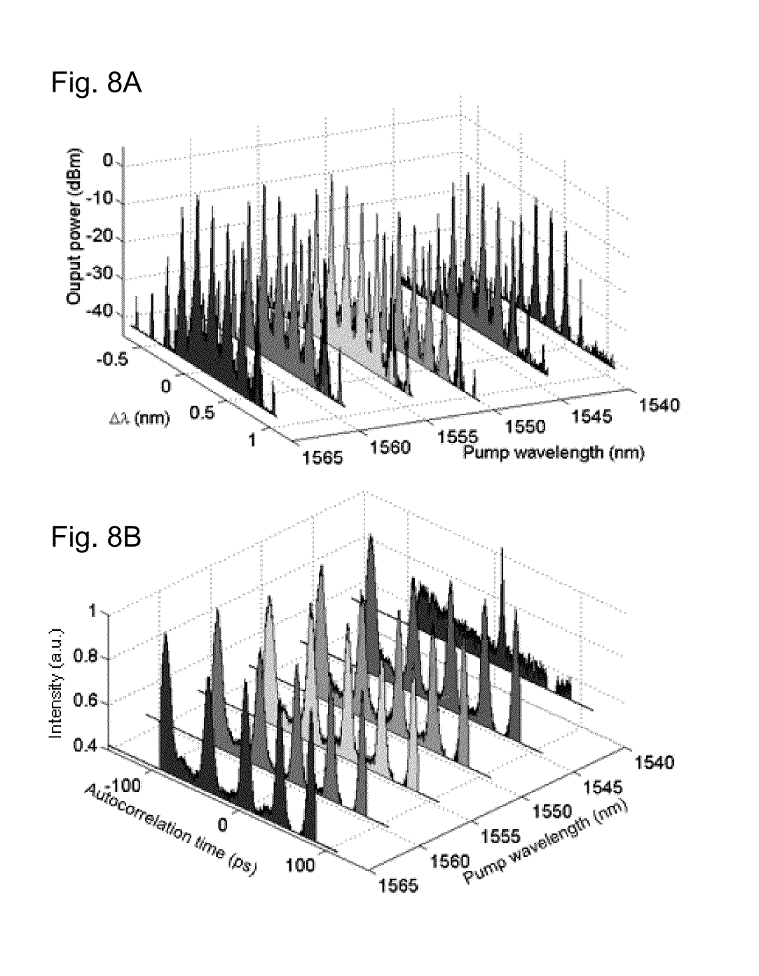

The output spectrum measured typically depends on the wavelength of the seed wave. However, with a tunable seed wave generator, it is possible to tune the wavelength of the output spectrum measured. FIGS. 8A and 8B show examples of, respectively, output spectrums and autocorrelation times measured at the output coupler 24 of the optical pulse generator configured as in FIG. 4. With a seed wave generator provided in the form of an erbium-doped fiber laser tunable as the seed wave generator tunable approximately from 1535 nm to approximately 1565 nm (C-band), it is possible to tune the output spectrum measured. By selecting the wavelength of the seed wave generator and by tuning the input seed power properly, the SBS generated waves can be spectrally shifted. Since each SBS wave depends on its generating wave of previous order, the phase locking that occurs between subsequent SBS waves do not depend on the wavelength of the seed wave generator so by tuning the wavelength of the seed wave, the wavelength of the output spectrum is also tuned.

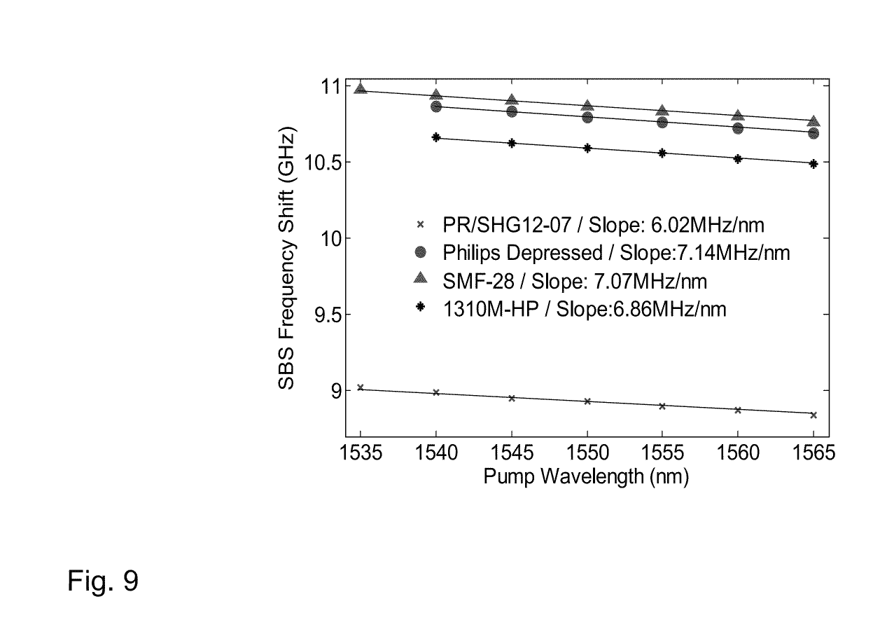

The repetition rate is also tunable. Indeed, the frequency spacing between two waves of consecutive order is dependent on the type of optical fiber used as the SBS gain medium. More particularly, the frequency shift is dependent on the core dopant of the optical fiber and its general profile of refractive index. FIG. 9 shows the frequency shift caused by SBS for different types of optical fibers such as PR/SHG12-07, Philips Depressed, SMF-28 and 1310-HP. Since the repetition rate of the optical pulse generator is dependent on the frequency shift, changing the type of fiber of the optical fiber 12 can be used to tune the repetition rate. The negative slope between the frequency shift and the wavelength is theoretically predicted and confirmed by the experiment shown in FIG. 9.

Now, since the cascade SBS phase-locking process and the repetition rate depends on the material properties of the optical fiber used as the SBS gain medium, and since that the frequency shift varies only slowly with temperature (−1 MHz/K) (Lambin lezzi, V., Loranger, S., Harhira, A., Kashyap, R., Saad, M., Gomes, A., and Rehman, S., “Stimulated Brillouin scattering in multi-mode fiber for sensing applications,” in Fibre and Optical Passive Components (WFOPC), 2011 7th Workshop on, 2011, pp. 1-4.), the output spectrum measured can be stable over long period of time (minutes). Thus, the output can be stable with small temperature change or convection in the near environment of the optical fiber.

Considering that the spectral shift of the waves generated by SBS varies linearly as a function of temperature and/or strain, it can be used as a strain-temperature sensor 44. Such a strain-temperature sensor 44 is shown in FIG. 10. It is known that with this configuration, the strain-temperature sensor 44 can act as a temperature sensor for an optical fiber having a constant or known strain. Inversely, the strain-temperature sensor can act as a strain sensor when used at a constant or known temperature. In this schematic diagram, two laser pulse generators configured as in FIG. 4 are provided in parallel, one being referred to as a sensing feedback cavity 48 and the other being referred to as a reference feedback cavity 46. These two cavities can incorporate filters 50 to limit the unnecessary amplification of the ASE and of the CW background discussed above as well as bidirectional erbium-doped fiber amplifier (BEDFA) 51 between the ports 2 of their respective optical circulators 40, 42. The seed wave generator 14 is equally divided in the two feedback cavities 46 and 48 using a 50/50 coupler 52. In the embodiment of FIG. 10, the optical fiber 12 of the sensing feedback cavity 48 is enclosed in a controlled environment 54 such as an oven 54′ where the temperature of a sensing optical fiber 53′ can be under test or a strain controllable configuration 54″ where the strain applied on a sensing optical fiber 53″ can be under test.

To observe the shifts of the waves of higher order, measurements with an electrical spectrum analyser (ESA) 58 or with an electro-optic modulator (EOM) typically with a bandwidth of 100 GHz or higher can be made. However, using, in parallel, the sensing feedback cavity 48 and the reference feedback cavity 46 coupled together with the 50/50 coupler 56 allows to measure beat frequencies with the standard ESA 58 (bandwidth below 1 GHz) at the base band using a known homodyne technique. Alternately, if the type of fiber (physical properties of the optical fiber, i.e. SBS frequency shift) 12 of the reference feedback cavity 46 is different from the type of fiber 53′,53″ of the sensing feedback cavity 48, an heterodyne scheme can be measured at a shifted frequency. In this configuration, cross-wave beating (wave of first order of the sensing feedback cavity 48 beating with the wave of second order of the reference feedback cavity 46) can be measured at higher frequencies (above 10 GHz) and is therefore generally neglected.

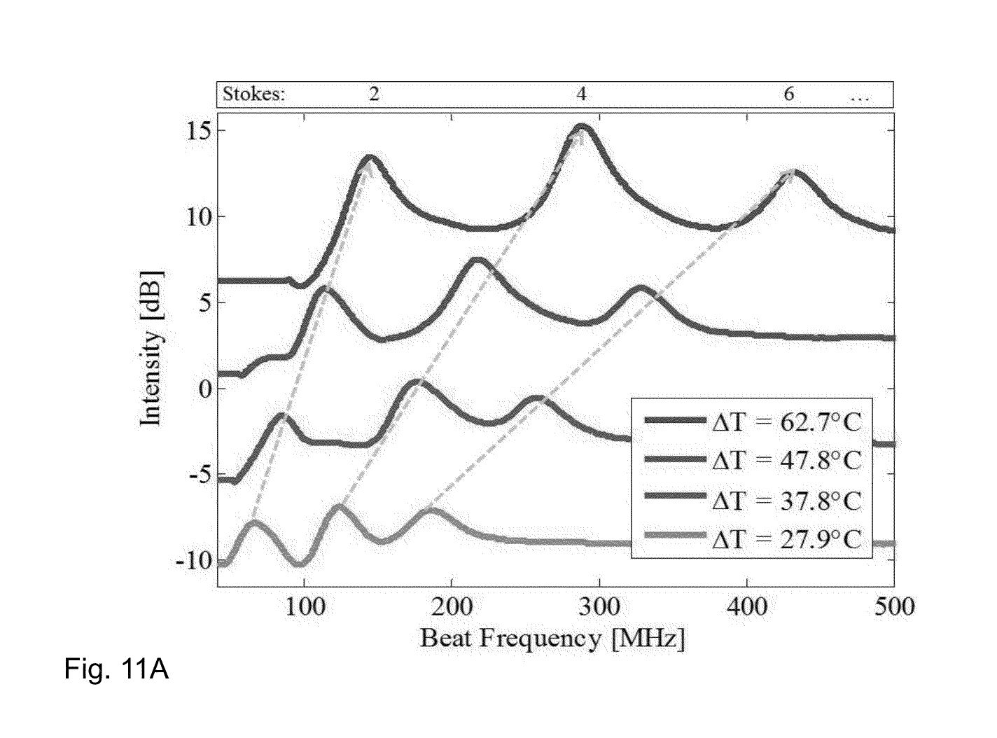

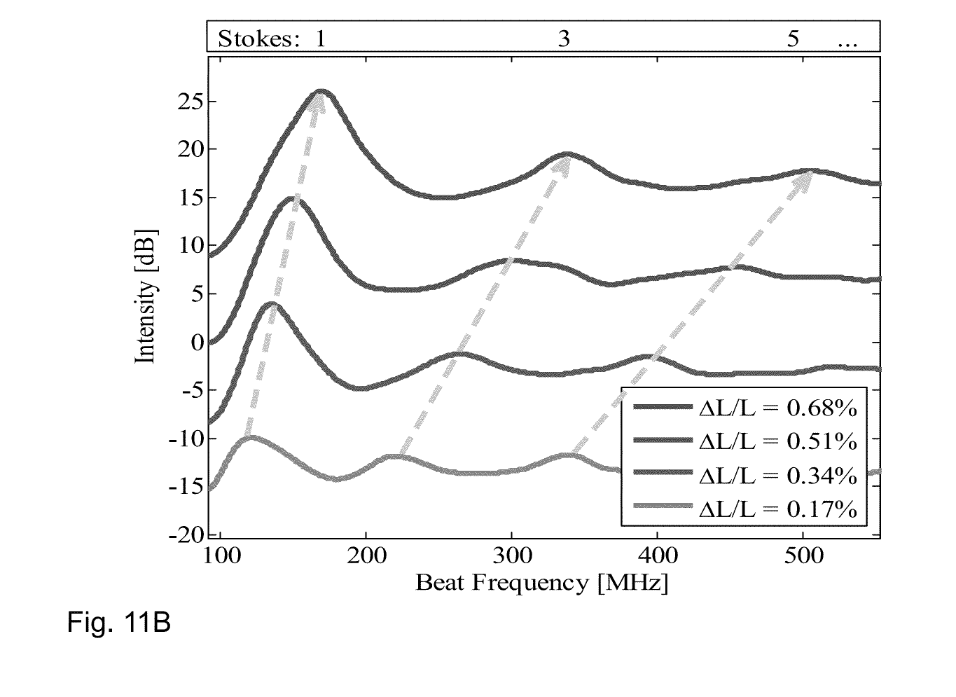

With the scheme of FIG. 10, all the orders of waves generated in the two feedback cavities 46 and 48 are mixed altogether. Since the two lengths of fiber 12 and 53′,53″ have typically the same SBS frequency shift, homodyne signals from the wave of first order of the reference feedback cavity 46 spectrally overlaps with the wave of first order of the sensing feedback cavity 48, a nominally zero frequency peak can be seen on the ESA 58 for the homodyne signals from all the orders of SBS waves generated. This allows a comparison of the Brillouin frequency shift difference for all the orders of waves generated simultaneously, as seen in FIGS. 11A and 11B. FIG. 11A shows the shifting of the SBS waves of second, fourth and sixth orders for different temperatures while FIG. 11B shows the shifting of the first, third and fifth orders for different strain applied on the sensing optical fiber 53″. The strain (or deformation) is measured as Δε=ΔL/L where ΔL is the difference of length (I_{deformed}-L, for instance) whereas L is the length of the sensing optical fiber 53″. However, to achieve a more sensitive strain-temperature sensor, the waves of highest order in the two feedback cavities 46 and 48 can be isolated and compared one to the other to achieve a higher sensitivity.

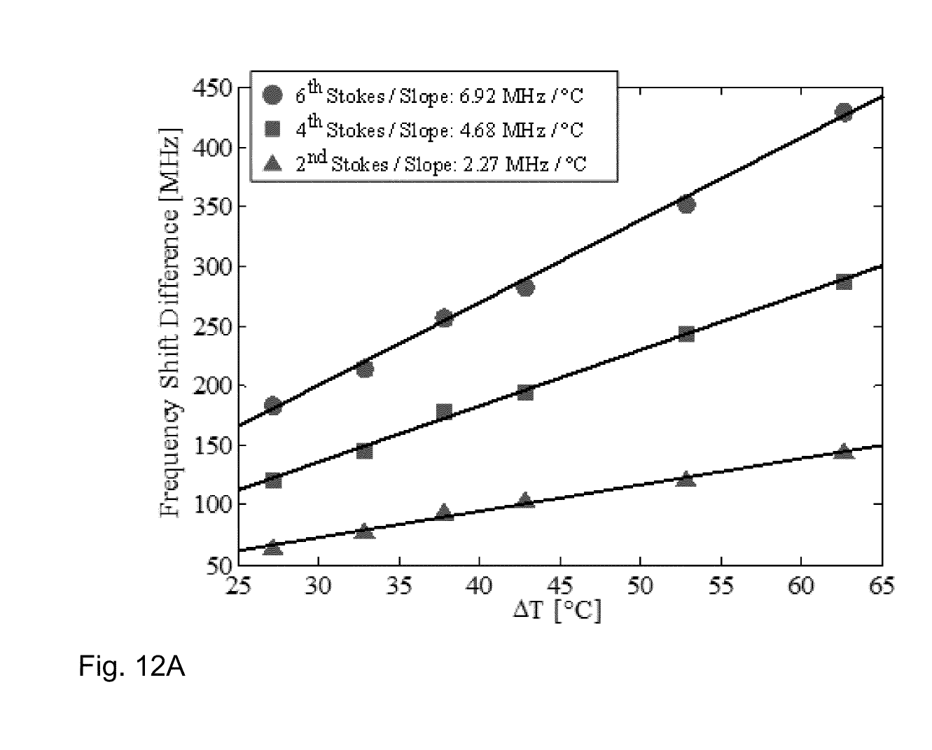

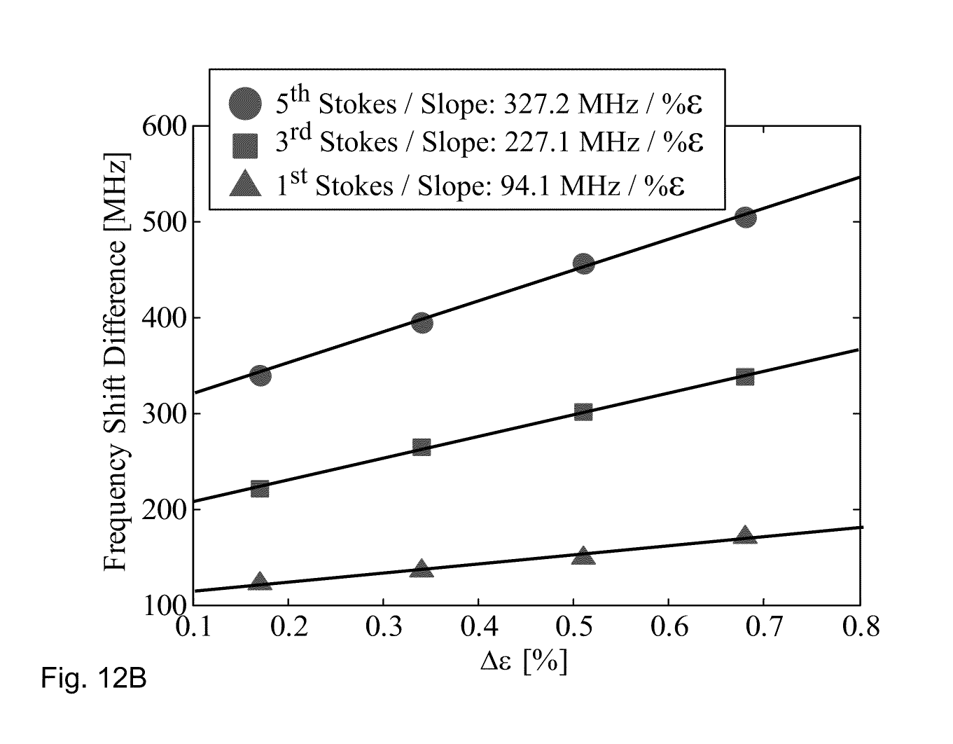

FIGS. 12A and 12B shows sensitivity slopes of the frequency shift difference as a function of, respectively, temperature difference ΔT and strain difference ΔE in the controlled environment 54. It was demonstrated that the SBS waves of higher orders are more sensitive to temperature differences that SBS waves of lower orders. Therefore, performing temperature or strain measurements based on the wave of highest order possible would yield a more sensitive strain-temperature sensor 44. Indeed, the sensitivity slope of the wave of sixth order is 6.92 MHz/K while the sensitivity slope of the wave of second order is 2.27 MHz/K. Indeed, the technique described herein increases the sensitivity by a factor n with respect with standard Brillouin temperature-strain sensors, wherein n corresponds to the number of generated SBS waves.

As can be seen therefore, the examples described above and illustrated are intended to be exemplary only. The scope is indicated by the appended claims.

What is claimed is:

1. A method for generating optical pulses, the method comprising the steps of:
propagating a seed wave in an optical fiber;
generating a wave of first order by stimulated Brillouin scattering of the seed wave in the optical fiber, the wave of first order having a frequency spectrally shifted from the seed wave and being backscattered from the seed wave;
propagating the seed wave and the wave of first order in a feedback cavity thereby generating a plurality of waves of higher order, each wave of higher order being cascadely generated by the wave of previous order, each wave of higher order being backscattered and having a frequency spectrally shifted from its corresponding wave of previous order and forming a frequency comb with the seed wave and the wave of first order; the frequency comb generating optical pulses; and
propagating the generated optical pulses out of the feedback cavity.

2. The method of claim 1, wherein optical fiber is a single mode fiber.

3. The method of claim 2, wherein the optical fiber has a length of at least 5 m, preferably at least about 1 km.

4. The method of claim 1, wherein the optical fiber is made of a nonlinear material.

5. The method of claim 4, wherein the optical fiber has a length of at least five centimeters.

6. The method of claim 1, wherein the generated optical pulses are femtosecond or picosecond pulses.

7. The method of claim 1 further comprising determining a desired repetition rate of the generated optical pulses and selecting the optical fiber as a function of the determined repetition rate.

8. The method of claim 1 further comprising providing a desired pulse width of the generated optical pulses; wherein the seed wave has a seed power which is amplified as a function of the desired pulse width.

9. The method of claim 1 further comprising providing a desired wavelength of the generated optical pulses; where the seed wave has a wavelength associated to the desired wavelength of the generated optical pulses.

10. The method of claim 1, wherein said propagating a seed wave further comprises amplifying the seed wave externally to the feedback cavity.

11. The method of claim 1, wherein said propagating the seed wave and the wave of first order in a feedback cavity further comprises amplifying the seed wave, the wave of first order and the generated waves of higher order in the feedback cavity.

12. The method of claim 1 further comprising selecting only the waves of even order in the generation of optical pulses.

13. The method of claim 1 further comprising selecting only the waves of odd order in the generation of optical pulses.

14. An optical pulse generator comprising:
a seed wave generator;
an optical fiber coupled to the seed wave generator, the optical fiber being adapted to generate a wave of first order by stimulated Brillouin scattering with the seed wave, the wave of first order having a frequency spectrally shifted from the seed wave and being backscattered from the seed wave;
a feedback cavity associated to the optical fiber, the feedback cavity configured to propagate, in the optical fiber, the seed wave, the wave of first order and a plurality of waves of higher order, each wave of higher order being cascadely generated by the wave of previous order, each wave of higher order being backscattered and having a frequency spectrally shifted from its generating wave thereby providing a frequency comb usable to generate optical pulses; and
an output coupler configured to propagate the generated optical pulses out of the feedback cavity.

15. The optical pulse generator of claim 14, wherein the optical fiber is a single mode fiber.

16. The optical pulse generator of claim 14, wherein the optical fiber is made of a nonlinear material.

17. The optical pulse generator of claim 14, wherein the generated optical pulses are femtosecond or picosecond pulses.

18. The optical pulse generator of claim 14, wherein an external optical amplifier is provided externally from the feedback cavity to amplify the seed wave.

19. The optical pulse generator of claim 14, wherein an input coupler is provided to couple the seed wave in the feedback cavity.

20. The optical pulse generator of claim 14, wherein an internal optical amplifier is provided inside the feedback cavity for optical amplification of the seed wave, the wave of first order and the waves of higher order.

21. The optical pulse generator of claim 14, wherein an optical circulator is optically connected in the feedback cavity and is configured to propagate the seed wave, the wave of first order and the waves of higher order to an end of the optical fiber, and further configured to propagate the backscattered waves back into the feedback cavity.

22. The optical pulse generator of claim 21, wherein a reflector is provided at the other end of the optical fiber.

23. The optical pulse generator of claim 22, wherein the reflector is a gold tipped fiber end.

24. The optical pulse generator of claim 14, wherein a second feedback cavity is connected to the feedback cavity by a first optical circulator and a second optical circulator and wherein the two feedback cavities share the optical fiber between the two optical circulators thereby maintaining the wave of even orders in the feedback cavity and maintaining the wave of odd orders in the second feedback cavity.

25. The optical pulse generator of claim 14, wherein the seed wave generator is an narrow-band laser diode followed by an erbium-doped fiber amplifier.

26. The optical pulse generator of claim 18, wherein the amplifier is an erbium-doped fiber amplifier.

27. Use of the optical pulse generator of claim 14 in a communication system.

28. Use of the optical pulse generator of claim 14 in an optical clock.

29. Use of the optical pulse generator of claim 14 in waveguide writing.

30. Use of the optical pulse generator of claim 14 in generation of nonlinear effects for sensing.

31. Use of the optical pulse generator of claim 14 in an optical time domain reflectometer.
